(19) United States
(12) Patent Application Publication
(10) Pub. No.: US 2016/0139462 A1
(43) Pub. Date: May 19, 2016

(54) CURVED LIQUID CRYSTAL DISPLAY

(71) Applicant: Samsung Display Co., Ltd., Yongin-City (KR)

(72) Inventor: Min Wook PARK, Asan-si (KR)

(21) Appl. No.: 14/683,000

(22) Filed: Apr. 9, 2015

(30) Foreign Application Priority Data
Nov. 18, 2014 (KR) 10-2014-0160940

(51) Int. Cl. G02F 1/1335; G02F 1/1333

(52) U.S. Cl. CPC G02F 1/133528; G02F 1/133345; G02F 2001/133531

(57) ABSTRACT

A curved liquid crystal display (LCD) includes a curved liquid crystal panel assembly including a first insulation substrate and a second insulation substrate facing each other and a liquid crystal layer interposed therebetween, a first polarizer disposed on the first insulation substrate, and a second polarizer disposed on the second insulation substrate. The first polarizer is disposed inside the curved liquid crystal panel assembly.

### CROSS-REFERENCE TO RELATED APPLICATION

This application claims priority to and the benefit of Korean Patent Application No. 10-2014-0160940 filed in the Korean Intellectual Property Office on Nov. 18, 2014, the entire contents of which are incorporated herein by reference.

### BACKGROUND

(a) Technical Field

The inventive concept generally relates to a curved liquid crystal display (LCD), and more particularly, to a curved LCD having reduced black mura.

(b) Description of the Related Art

Liquid crystal displays (LCDs) are widely used as flat panel displays. A liquid crystal display (LCD) typically includes two display panels on which field generating electrodes (such as a pixel electrode and a common electrode) are formed, and a liquid crystal layer interposed between the two display panels. An electric field is generated on a liquid crystal layer by applying a voltage to the field generating electrodes. The electric field determines the alignment directions of liquid crystal molecules of the liquid crystal layer, and controls polarization of incident light passing through the liquid crystal layer, so as to display an image on the LCD.

In recent years, the size of LCDs has increased and curved displays have been developed to enhance viewer immersion. By applying an external force to a flat LCD, a curved LCD having a constant curvature can be formed.

However, in some instances, differences in curvature in a glass substrate may cause the shear stresses in the substrate to vary and result in phase retardation, which leads to a phenomenon known as black mura. Black mura refers to display areas that have a greater brightness compared to other display areas when the curved LCD is displaying a black screen. The difference in brightness between the display areas is due to light leakage. Accordingly, the occurrence of black mura causes the display quality of curved LCDs to deteriorate.

The above information disclosed in this Background section is only to enhance understanding of the background of the inventive concept and may contain information that does not constitute prior art that is known in this country to one of ordinary skill in the art.

### SUMMARY

The present disclosure addresses at least the above issues in the prior art.

According to an exemplary embodiment of the inventive concept, a curved liquid crystal display (LCD) is provided. The curved LCD includes a curved liquid crystal panel assembly including a first insulation substrate and a second insulation substrate facing each other and a liquid crystal layer interposed therebetween, a first polarizer disposed on the first insulation substrate, and a second polarizer disposed on the second insulation substrate, wherein the first polarizer is disposed inside the curved liquid crystal panel assembly.

In some embodiments, the first polarizer may be disposed in a first region corresponding to a black mura region in which black mura generated in the curved liquid crystal panel assembly appears.

In some embodiments, the first polarizer may be disposed in a second region corresponding to a normal region excluding the black mura region.

In some embodiments, the second polarizer may be disposed in the first region corresponding to the black mura region.

In some embodiments, the second polarizer may be disposed in the second region corresponding to the normal region.

In some embodiments, a shear stress of the liquid crystal panel assembly may be higher in the black mura region than in the normal region.

In some embodiments, the second polarizer may be disposed inside the curved liquid crystal panel assembly.

In some embodiments, the second polarizer may be disposed outside the curved liquid crystal panel assembly.

In some embodiments, a first polarization axis of the first polarizer and a second polarization axis of the second polarizer may be perpendicular to each other.

In some embodiments, the curved liquid crystal panel assembly may be formed having a predetermined constant curvature.

In some embodiments, the curved liquid crystal panel assembly may be formed having multiple curvatures such that its center portion has a different curvature from the lateral edge portions.

In some embodiments, the liquid crystal layer may include a plurality of liquid crystal molecules, and the plurality of liquid crystal molecules may be aligned such that they are perpendicular to surfaces of the first and second insulation substrates when no electric field is being generated in the liquid crystal panel assembly.

According to another exemplary embodiment of the inventive concept, a curved liquid crystal display (LCD) is provided. The curved LCD includes a curved liquid crystal panel assembly including a first polarizer and a second polarizer facing each other. The first polarizer is positioned inside the curved liquid crystal panel assembly, and disposed in a first region corresponding to a black mura region in which black mura generated in the curved liquid crystal panel assembly appears.

In some embodiments, the second polarizer may be disposed inside the curved liquid crystal panel assembly and disposed in the first region corresponding to the black mura region.

In some embodiments, the first polarizer may be disposed in a second region corresponding to a normal region excluding the black mura region.

In some embodiments, the second polarizer may be disposed in the second region corresponding to the normal region.

In some embodiments, a shear stress of the liquid crystal panel assembly may be higher in the black mura region than in the normal region.

In some embodiments, the second polarizer may be disposed inside the curved liquid crystal panel assembly.

In some embodiments, the second polarizer may be disposed outside the curved liquid crystal panel assembly.

### BRIEF DESCRIPTION OF THE DRAWINGS

FIG. 1 is a block diagram of a curved liquid crystal display (LCD) according to an exemplary embodiment.

FIG. 2 is a circuit diagram of a pixel of the curved LCD of FIG. 1.

FIG. 3 is a top plan view of a pixel of the curved LCD of FIG. 1.

FIG. 4 is a cross-sectional view of the pixel of FIG. 3 taken along line IV-IV.

FIG. 5 is a schematic drawing illustrating a curved liquid crystal panel assembly in a curved LCD according to an exemplary embodiment.

FIG. 6 is a simulation result of the shear stress in the curved liquid crystal panel assembly in the curved LCD of FIG. 6.

FIG. 7 is a top plan view illustrating polarization variations in the curved LCD according to an exemplary embodiment.

FIG. 8 is a cross-sectional view illustrating a curved LCD according to a comparative example.

FIG. 9 is a top plan view illustrating polarization variations in a black mura region in the curved LCD of FIG. 8.

FIG. 10 is a cross-sectional view illustrating a curved LCD according to another exemplary embodiment.

### DETAILED DESCRIPTION

The inventive concept will be described more fully herein with reference to the accompanying drawings, in which exemplary embodiments are shown.

As one of ordinary skill in the art would realize, the embodiments may be modified in various ways without departing from the spirit or scope of the inventive concept.

In this specification, when an element is described as being “coupled” to another element, the element may be directly coupled to the other element or coupled to the other element via a another element. Also, it will be understood that when an element such as a layer, film, region, or substrate is referred to as being “on” another element, it can be directly on the other element or with one or more intervening elements being present. In contrast, when an element is referred to as being “directly on” another element, there are no intervening elements present.

In addition, unless specified otherwise, the word “comprise” and variations such as “comprises” or “comprising” will be understood to imply the inclusion of stated elements but not the exclusion of any other elements.

In the drawings, the thickness of layers, films, panels, regions, etc. may be exaggerated for clarity. Same or similar constituent elements are designated by the same reference numerals throughout the specification.

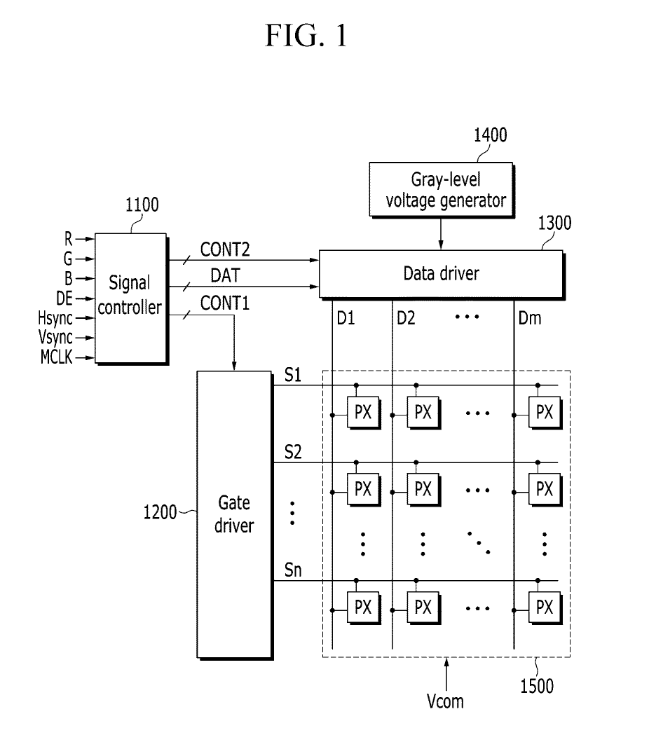

A curved liquid crystal display (LCD) according to an exemplary embodiment is first described in detail with reference to FIGS. 1, 2, 3, and 4.

FIG. 1 is a block diagram of the curved LCD according to the exemplary embodiment. Referring to FIG. 1, the curved LCD includes a signal controller 1100, a gate driver 1200, a data driver 1300, a gray-level voltage generator 1400, and a liquid crystal panel assembly 1500.

The liquid crystal panel assembly 1500 includes a plurality of gate lines S1 to Sn, a plurality of data lines D1 to Dm, and a plurality of pixels PX. The plurality of pixels PX are arranged in an approximate matrix form, and are connected to the gate lines S1 to Sn and the data lines D1 to Dm. The plurality of gate lines S1 to Sn extend substantially in a row direction such that the gate lines are approximately parallel to one another. The plurality of data lines D1 to Dm extend substantially in a column direction such that the data lines are approximately parallel to one another.

Although FIG. 1 illustrates only the plurality of gate lines S1 to Sn and data lines D1 to Dm being connected to the plurality of pixels PX, it should be understood that other signal lines (such as a power supply line, a divided reference voltage line, etc.) may also be connected to the plurality of pixels PX. The type of signal lines that are connected may depend on the structure of the pixels PX, a driving method for the curved LCD, etc.

In some embodiments, a backlight (not shown) may be provided at a rear side of the liquid crystal panel assembly 1500 to control luminance of an image displayed on the liquid crystal panel assembly 1500. The backlight is configured to emit light to the liquid crystal panel assembly 1500.

The signal controller 1100 is configured to receive image signals R, G, and B, and an input control signal. The image signals R, G, and B contain luminance information of the plurality of pixels. The luminance information may include a predetermined number of gray levels, for example, 1024 (2¹⁰), 256 (2⁸), or 64 (2⁶) gray levels. The input control signal includes a data enable signal DE, a horizontal synchronization signal Hsync, a vertical synchronization signal Vsync, and a main clock signal MCLK.

The signal controller 1100 is also configured to generate a gate control signal CONT1, a data control signal CONT2, and an image data signal DAT according to the image signals R, G, and B, the data enable signal DE, the horizontal synchronization signal Hsync, the vertical synchronization signal Vsync, and the main clock signal MCLK.

The signal controller 1100 is further configured to identify the image signals R, G, and B for each frame according to the vertical synchronization signal Vsync and for each gate line according to the horizontal synchronization signal Hsync, thereby generating the image data signal DAT.

The signal controller 1100 may provide the image data signal DAT and the data control signal CONT2 to the data driver 1300. The data control signal CONT2 is a signal for controlling an operation of the data driver 1300. The data control signal CONT2 includes a horizontal synchronization start signal STH for instructing a transmission start of the image data signal DAT, a load signal LOAD for instructing the data lines D1 to Dm to output a data signal, and a data clock signal HCLK. The data control signal CONT2 may further include a reverse signal RVS for reversing a voltage polarity of the image data signal DAT with respect to a common voltage Vcom.

The signal controller 1100 also provides the gate control signal CONT1 to the gate driver 1200. The gate control signal CONT1 includes at least one clock signal for controlling output of a scanning start signal STV and a gate-on voltage of the gate driver 1200. The gate control signal CONT1 may further include an output enable signal OE for limiting duration of the gate-on voltage.

The data driver 1300 is connected to the data lines D1 to Dm of the liquid crystal panel assembly 1500, and is configured to select gray-level voltages from the gray-level voltage generator 1400. The data driver 1300 applies a selected gray-level voltage as a data signal to the respective data lines D1 to Dm. It should be noted that the gray-level voltage generator 1400 need not provide voltages for all gray levels, but may provide only a predetermined number of reference gray-level voltages. For example, the data driver 1300 may divide the reference gray-level voltages to generate the gray-level voltages for all the gray levels, and then select one or more data signals from among the gray-level voltages for all the gray levels.

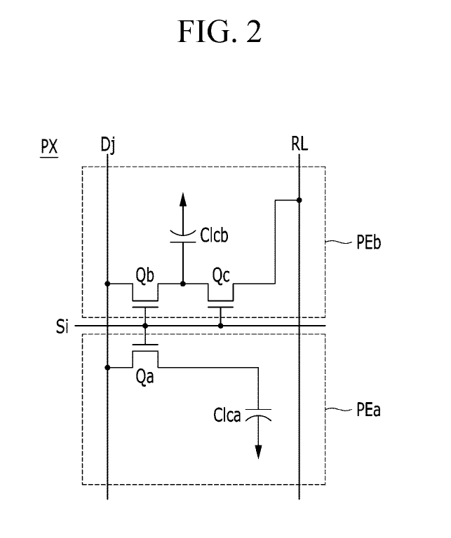

The gate driver 1200 is configured to apply a gate signal to the gate lines S1 to Sn. The gate signal includes a gate-on voltage for turning on, and a gate-off voltage for turning off, the switching elements (Qa, Qb, and Qc of FIG. 2) that are connected to the gate lines S1 to Sn of the liquid crystal panel assembly 1500.

The signal controller 1100, the gate driver 1200, the data driver 1300, and the gray-level voltage generator 1400 may be integrated into at least one integrated circuit (IC) chip, and directly mounted on the liquid crystal panel assembly 1500 or on a flexible printed circuit film (not shown). In some embodiments, the signal controller 1100, the gate driver 1200, the data driver 1300, and the gray-level voltage generator 1400 may be provided in the form of a tape carrier package (TCP), and attached to the liquid crystal panel assembly 1500 or mounted on a printed circuit board (PCB) (not shown).

Alternatively, in some other embodiments, the signal controller 1100, the gate driver 1200, the data driver 1300, and the gray-level voltage generator 1400 may be integrated into the liquid crystal panel assembly 1500 along with the signal lines S1 to Sn and D1 to Dm.

Next, a circuit structure of a pixel of an exemplary curved LCD and a driving method thereof will be described with reference to FIG. 2. Specifically, FIG. 2 is a circuit diagram of a pixel of the curved LCD of FIG. 1.

Referring to FIG. 2, the pixel PX includes first to third switching elements Qa, Qb, and Qc, and first and second liquid crystal capacitors Clca and Clcb. The first and second switching elements Qa and Qb are respectively connected to a gate line Si and a data line Dj. The third switching element Qc is connected to the gate line Si, an output terminal of the second switching element Qb, and a divided reference voltage line RL.

The first and second switching elements Qa and Qb are three-terminal elements such as a thin film transistor and the like. Control terminals of the first and second switching elements Qa and Qb are connected to the gate line Si, and input terminals of the first and second switching elements Qa and Qb are connected to the data line Dj. An output terminal of the first switching element Qa is connected to the first liquid crystal capacitor Clca. An output terminal of the second switching element Qb is connected to the second liquid crystal capacitor Clcb and an input terminal of the third switching element Qc.

The third switching element Qc is also a three-terminal element such as a thin film transistor and the like. A control terminal of the third switching element Qc is connected to the gate line Si, an input terminal of the third switching element Qc is connected to the second liquid crystal capacitor Clcb, and an output terminal of the third switching element Qc is connected to the divided reference voltage line RL.

When a gate-on signal is applied to the gate line Si, the first, second, and third switching elements Qa, Qb, and Qc connected thereto are turned on.

In the above embodiment, a data signal is applied to the data line Dj, and the data signal applied to the data line Dj is applied to a first subpixel electrode PEa through the turned-on first switching element Qa and to a second subpixel electrode PEb through the turned-on second switching element Qb.

Since the data signals applied to the first and second subpixel electrodes PEa and PEb are identical to each other, the first and second liquid crystal capacitors Clca and Clcb are charged with a same amount of charge corresponding to a difference between the common voltage Vcom and the data voltage. At the same time, a voltage in the charged second liquid crystal capacitor Clcb is divided by the turned-on third switching element Qc. Thus, the voltage in the charged second liquid crystal capacitor Clcb is reduced by a difference between the common voltage Vcom and the divided reference voltage.

Since the voltages of the first and second liquid crystal capacitors Clca and Clcb are different, tilt angles of liquid crystal molecules of the first and second subpixels will be different, thereby yielding two subpixels of different luminances.

Accordingly, by adjusting the voltages of the first and second liquid crystal capacitors Clca and Clcb, an image viewed from a side of the curved LCD will be similar to an image viewed from the front of the curved LCD. In other words, side visibility is improved.

In the example of FIG. 2, the pixel is shown having a particular circuit configuration. However, it should be noted that the pixel circuit in FIG. 2 is merely exemplary, and that the pixel may be formed having different circuit configurations in other embodiments.

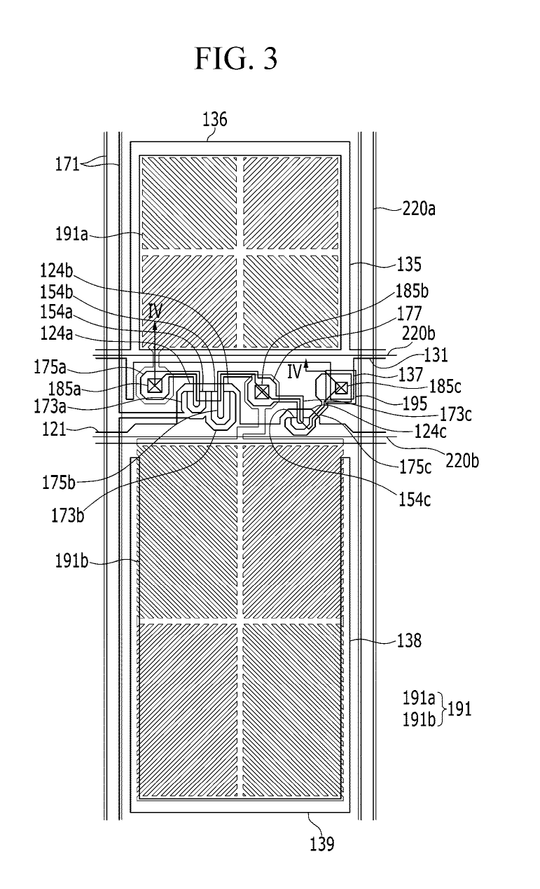

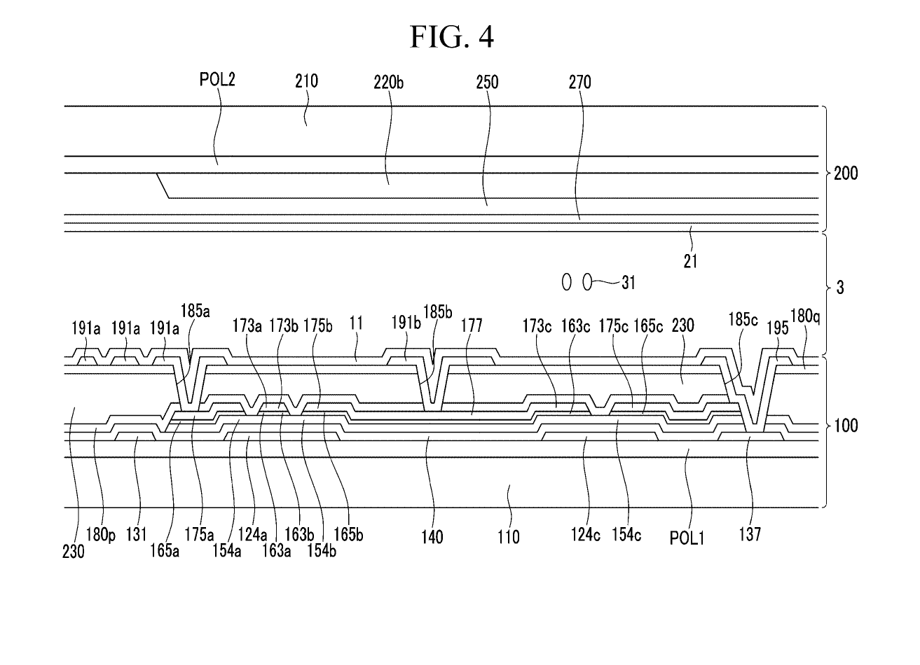

Next, a structure of the liquid crystal panel assembly 1500 of the curved LCD according to the exemplary embodiment will be described with reference to FIGS. 3 and 4. Specifically, FIG. 3 is a top plan view of a pixel of the curved LCD of FIG. 1, and FIG. 4 is a cross-sectional view of the pixel of FIG. 3 taken along line IV-IV.

Referring to FIGS. 3 and 4, the curved liquid crystal panel assembly 1500 includes lower and upper panels 100 and 200 facing each other, and a liquid crystal layer 3 including liquid crystal molecules 31 interposed between the two display panels 100 and 200.

First, the structure of the lower panel 100 is described as follows.

As shown in FIG. 4, a first polarizer POL1 is disposed on a first insulation substrate 110. The first insulation substrate 110 may be formed of transparent glass or plastic. The first polarizer POL1 may be formed on the first insulation substrate 110 by forming minute patterns using a graphoepitaxy process in which a block copolymer is self-assembled. Alternatively, the first polarizer POL1 may be formed as a film attached to the first insulation substrate 110. Since the first polarizer POL1 includes minute patterns, linearly polarized light in a direction of a first polarization axis is transmitted through the first polarizer POL1.

A gate conductor is disposed on the first polarizer POL1. The gate conductor includes a gate line 121 and a divided reference voltage line 131. The gate line 121 includes a first gate electrode 124a, a second gate electrode 124b, a third gate electrode 124c, and a wide end portion (not shown) for connecting with another layer or an external driving circuit. The divided reference voltage line 131 includes first storage electrodes 135 and 136, and a reference electrode 137. Second storage electrodes 138 and 139 are also disposed overlapping a second subpixel electrode 191b without connecting with the divided reference voltage line 131.

A gate insulating layer 140 is disposed on the gate line 121 and the divided reference voltage line 131. A first semiconductor layer 154a, a second semiconductor layer 154b, and a third semiconductor layer 154c are disposed on the gate insulating layer 140. A plurality of ohmic contacts 163a, 165a, 163b, 165b, 163c, and 165c are disposed on the semiconductor layers 154a, 154b, and 154c. A plurality of data lines 171 and a data conductor are disposed on the ohmic contacts 163a, 165a, 163b, 165b, 163c, and 165c and the gate insulating layer 140. The plurality of data lines 171 include first and second source electrodes 173a and 173b. The data conductor includes a first drain electrode 175a, a second drain electrode 175b, a third source electrode 173c, and a third drain electrode 175c.

The data conductor, along with the semiconductor layers and the ohmic contacts disposed thereunder, may be simultaneously formed using one mask.

The data line 171 includes a wide end portion (not shown) for connecting with another layer or an external driving circuit, and may include the semiconductor layers 154a, 154b, and 154c and the ohmic contacts 163a, 165a, 163b, 165b, 163c, and 165c having the same planar shape.

The first gate electrode 124a, the first source electrode 173a, and the first drain electrode 175a, together with the first semiconductor layer 154a, collectively constitute a first thin film transistor Qa. A channel of the first thin film transistor Qa is formed in the first semiconductor layer 154a between the first source electrode 173a and the first drain electrode 175a.

Similarly, the second gate electrode 124b, the second source electrode 173b, and the second drain electrode 175b, together with the second semiconductor layer 154b, collectively constitute a second thin film transistor Qb. A channel of the second thin film transistor Qb is formed in the second semiconductor layer 154b between the second source electrode 173b and the second drain electrode 175b. The second drain electrode 175b is connected to the third source electrode 173c and includes a wide expanded portion 177. Likewise, the third gate electrode 124c, the third source electrode 173c, and the third drain electrode 175c, together with the third semiconductor layer 154c, collectively constitute a third thin film transistor Qc. A channel of the third thin film transistor Qc is formed in the third semiconductor layer 154c between the third source electrode 173c and the third drain electrode 175c.

A first passivation layer 180p is disposed on the data conductors 171, 173c, 175a, 175b, and 175c, and on exposed portions of the semiconductor layers 154a, 154b, and 154c. The first passivation layer 180p may be an inorganic insulating layer formed of a silicon nitride or a silicon oxide. The first passivation layer 180p may prevent a pigment of a color filter 230 from flowing into the exposed portions of the semiconductor layers 154a, 154b, and 154c.

A vertical light blocking member 220a and the color filter 230 are disposed on the first passivation layer 180p. In some alternative embodiments, only one of the vertical light blocking member 220a and the color filter 230 may be disposed on the first passivation layer 180p. The vertical light blocking member 220a may have a planar shape that is identical or similar to the data line 171, and is formed covering the data line 171. In the example of FIG. 3, the light blocking member 220a is shown extending in a vertical direction. However, the inventive concept is not limited thereto, and the light blocking member 220a may extend in other directions in other embodiments. In some alternative embodiments, the light blocking member 220a may be replaced by a shielding electrode that is simultaneously formed with the pixel electrode and to which the common voltage is applied.

The color filter 230 extends in the vertical direction along two data lines adjacent to each other. Two adjacent color filters 230 may be spaced apart by the data lines 171, or overlap each other in the vicinity of the data lines 171. The color filter 230 may display one of primary colors, for example, the three primary colors red, green, and blue. In some embodiments, the color filter 230 may display one of other colors such as yellow, cyan, and magenta. Although not illustrated, the color filter 230 may further include a color filter for displaying a mixture of the primary colors in addition to the primary colors, and/or white color.

A second passivation layer 180q is disposed on the vertical light blocking member 220a and the color filter 230. The second passivation layer 180q may be an inorganic insulating layer formed of a silicon nitride or a silicon oxide. The second passivation layer 180q prevents the color filter 230 from being lifted off. The second passivation layer 180q also protects the liquid crystal layer 3 from being contaminated by an organic material (for example, a solvent from the color filter 230), thereby preventing display defects (such as a residual image) that may appear when a screen image is being driven.

A first contact hole 185a and a second contact hole 185b are formed in the first passivation layer 180p, the color filter 230, and the second passivation layer 180q to respectively expose the first and second drain electrodes 175a and 175b. A third contact hole 185c is formed in the first passivation layer 180p, the second passivation layer 180q, and the gate insulating layer 140 to partially expose both of the reference electrode 137 and the third drain electrode 175c.

A connecting member 195 is formed covering the third contact hole 185c. The connecting member 195 electrically couples the reference electrode 137 and the third drain electrode 175c that are exposed by the third contact hole 185c.

A plurality of pixel electrodes 191 are disposed on the second passivation layer 180q, and a lower alignment layer 11 is disposed on the pixel electrode 191. The pixel electrodes 191 are separated from each other with the gate line 121 interposed therebetween. The pixel electrodes 191 include a first subpixel electrode 191a and a second subpixel electrode 191b neighboring each other in a column direction with respect to the gate line 121. The pixel electrodes 191 may be formed of a transparent conductive material such as ITO, IZO, or the like, or a reflective metal such as aluminum, silver, chromium, or an alloy thereof. The first subpixel electrode 191a is physically and electrically connected to the first drain electrode 175a through the first contact hole 185a, and the data signal from the first drain electrode 175a is applied to the first subpixel electrode 191a. The second subpixel electrode 191b is physically and electrically connected to the second drain electrode 175b through the second contact hole 185b, and the data signal from the second drain electrode 175b is applied to the second subpixel electrode 191b. The data signal that is applied to the second drain electrode 175b may be partially divided by the third source electrode 173c such that a voltage applied to the first subpixel electrode 191a is greater than a voltage applied to the second subpixel electrode 191b.

When the data signal is applied to the first and second subpixel electrodes 191a and 191b, an electric field is generated by the first and second subpixel electrodes 191a and 191b in conjunction with a common electrode 270 of the upper panel 200. The electric field determines the directions of the liquid crystal molecules of the liquid crystal layer 3 between the two electrodes 191 and 270. Accordingly, luminance of light passing through the liquid crystal layer 3 varies depending on the determined directions of the liquid crystal molecules.

Next, the structure of the upper panel 200 is described as follows.

As shown in FIG. 4, a second polarizer POL2 is disposed on a second insulation substrate 210. The second polarizer POL2 may be formed of transparent glass or plastic. The second polarizer POL2 may be formed on the second insulation substrate 210 by forming minute patterns using a graphoepitaxy process in which a block copolymer is self-assembled. Alternatively, the second polarizer POL2 may be formed as a film attached to the second insulation substrate 210. Since the second polarizer POL2 includes minute patterns, linearly polarized light in the direction of a second polarization axis that is perpendicular to the direction of the first polarization axis of the first polarizer POL1 is transmitted through the second polarizer POL2.

Since the first and second polarizers POL1 and POL2 are disposed inside the pixel cells of the curved liquid crystal panel assembly 1500, the polarizers POL1 and POL2 are therefore not disposed outside of the first and second insulation substrate 110 and 210.

A horizontal light blocking member 220b is disposed on the second polarizer POL2. The horizontal light blocking member 220b is referred to as a black matrix (BM) and prevents leakage of light. The horizontal light blocking member 220b may be disposed corresponding to the gate line 121. As such, the horizontal light blocking member 220b may extend in the row direction.

An overcoat 250 is formed on the horizontal light blocking member 220b. The overcoat 250 may be formed of an organic insulating material, and provides a flat planar surface. In some particular embodiments, the overcoat 250 may be omitted. A common electrode 270 is formed on the overcoat 250. The common electrode 270 may be formed of a transparent conductor such as ITO, IZO, etc. An upper alignment layer 21 is formed on the common electrode 270.

The liquid crystal layer 3 includes the plurality of liquid crystal molecules 31, and the liquid crystal molecules 31 are aligned such that they are perpendicular to the surfaces of the insulation substrates 110 and 210 when a turn-on voltage is applied to the field generating electrodes 191 and 270.

The liquid crystal molecules 31 may be aligned having pretilts, so that the liquid crystal molecules 31 are tilted in the same direction as a length direction of cutout patterns of the pixel electrode 191.

In the embodiment of FIGS. 3 and 4, the pixel of the curved LCD has a vertical type of pixel structure whereby a vertical length of the pixel is longer than a horizontal length of the pixel. However, the inventive concept is not limited thereto. In some other embodiments, the pixel of the curved LCD may have a horizontal type of pixel structure whereby the horizontal length of the pixel is longer than the vertical length of the pixel.

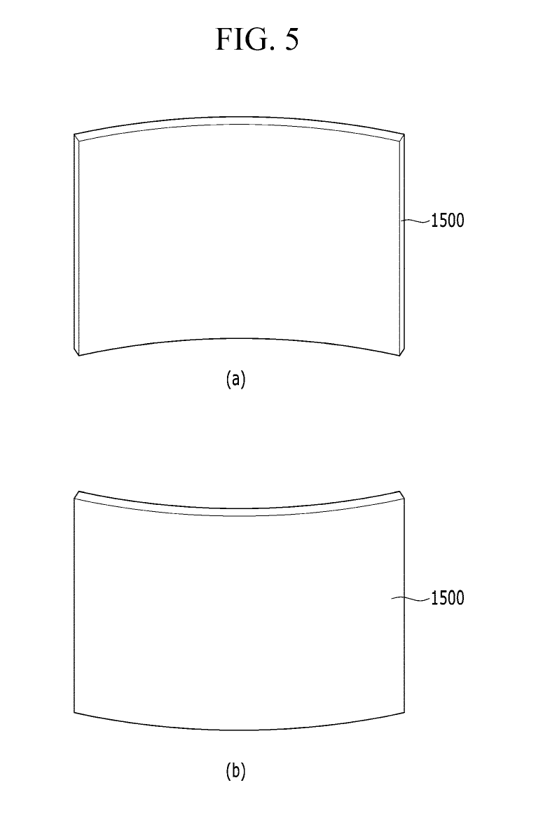

FIG. 5 is a schematic drawing illustrating a curved liquid crystal panel assembly in a curved LCD according to an exemplary embodiment. Referring to FIG. 5, the liquid crystal panel assembly 1500 of the curved LCD may be formed as either a concave type (shown in FIG. 5(a)) or a convex type (shown in FIG. 5(b)). The concave type has a shape in which a center portion of the liquid crystal panel assembly 1500 is disposed behind opposite lateral edges, as observed by a viewer positioned in front of the liquid crystal panel assembly 1500. The convex type has a shape in which a center portion of the liquid crystal panel assembly 1500 protrudes in front of opposite lateral edges, as observed by a viewer positioned in front of the liquid crystal panel assembly 1500.

The concave type or the convex type of liquid crystal panel assembly 1500 may be formed having a constant curvature. In some embodiments, the liquid crystal panel assembly 1500 may be formed having multiple curvatures such that a curvature of the center portion of the liquid crystal panel assembly 1500 is different from a curvature of the opposite lateral edge portions. It is noted that a liquid crystal panel assembly 1500 with a constant curvature is likely to have more severe occurrences of black mura compared to another liquid crystal panel assembly 1500 with multiple curvatures.

In the interest of simplicity, it is herein assumed that the liquid crystal panel assembly 1500 is formed as the concave type.

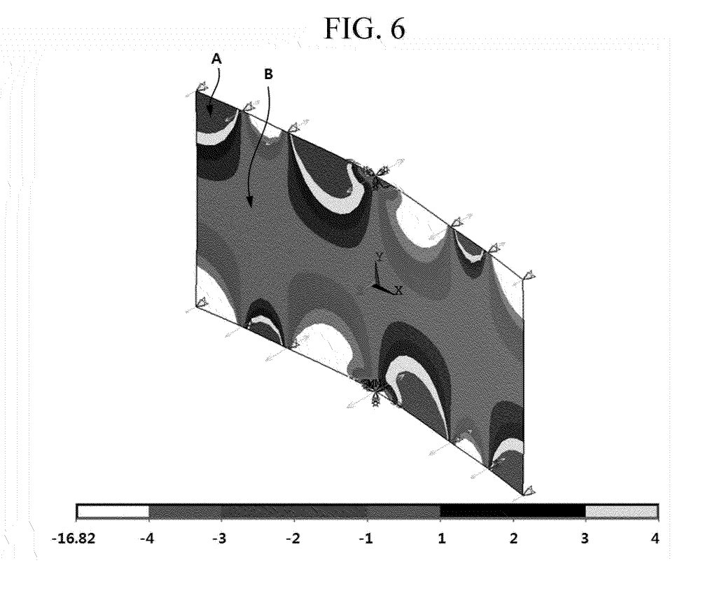

FIG. 6 is a simulation result of the shear stress in the curved liquid crystal panel assembly in the curved LCD of FIG. 6. Referring to FIG. 6, when the liquid crystal panel assembly 1500 has the constant curvature or the multiple curvatures due to an external force, a shear stress of a material against a shear force is generated to maintain a state before the application of the external force.

As illustrated in FIG. 6, a screen of the liquid crystal panel assembly 1500 includes a region A and a region B. Within the region A, a relatively higher shear stress is distributed in upper and lower edge portions of the region A. In contrast, within the region B, a relatively lower shear stress is distributed in a center portion of the region B. The region A corresponds to a black mura region in which black mura occurs. The region B corresponds to a normal region excluding the black mura region. The distribution of shear stress within the region A may be determined by a curvature radius of the liquid crystal panel assembly 1500, thicknesses of the first and second insulation substrates 110 and 210, etc. Accordingly, the distribution of the black mura region may be determined by a curvature radius of the liquid crystal panel assembly 1500, thicknesses of the first and second insulation substrates 110 and 210, etc. The distribution of the black mura region can be normalized by adjusting the curvature radius of the liquid crystal panel assembly 1500, the thicknesses of the first and second insulation substrates 110 and 210, etc. based on a predetermined specification.

In the curved LCD according to the exemplary embodiment, since the first and second polarizers POL1 and POL2 are disposed inside the pixel cells, black mura will not occur even though there are shear stresses in the liquid crystal panel assembly 1500. Specifically, the first and second polarizers POL1 and POL2 disposed inside the pixel cells may be disposed in a region corresponding to the black mura region in the curved liquid crystal panel assembly 1500, as well as a region corresponding to the normal region in the curved liquid crystal panel assembly 1500. That is, the first and second polarizers POL1 and POL2 may be disposed covering an entire curved screen of the liquid crystal panel assembly 1500.

In some alternative embodiments, the first and second polarizers POL1 and POL2 disposed inside the pixel cells may be disposed only in the region corresponding to the black mura region in the curved liquid crystal panel assembly 1500. In those alternative embodiments, an additional polarizer may be disposed outside the pixel cells in the region corresponding to the normal region.

In the liquid crystal panel assembly 1500 of the curved LCD described in FIGS. 3 and 4, the first polarizer POL1, the first insulation substrate 110, the liquid crystal layer 3, the second insulation substrate 210, and the second polarizer POL2 contribute to polarization variations of light emitted from the backlight. In the interest of clarity, only the key elements contributing to the polarization variations of light will be illustrated.

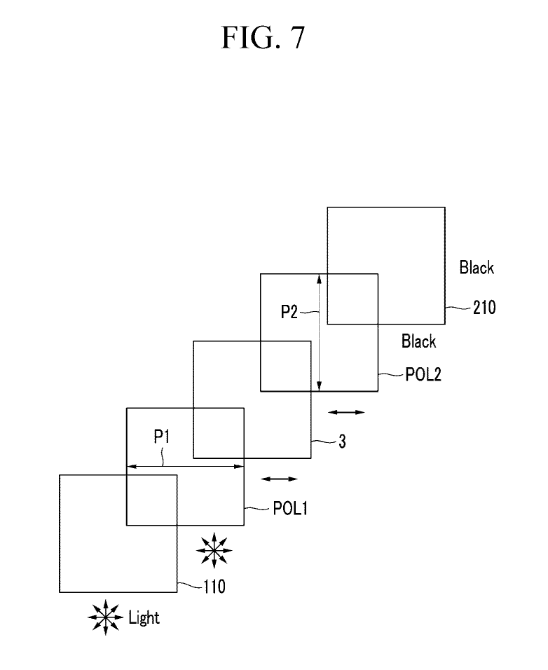

FIG. 7 is a top plan view illustrating polarization variations in the curved LCD according to an exemplary embodiment. Referring to FIG. 7, it may be assumed that the curved LCD displays a black image and light is provided from the backlight to the liquid crystal panel assembly 1500. The light emitted from the backlight is unpolarized light in which electric fields are substantially uniform in all directions. The unpolarized light may be transmitted through the region A where the sheer stress occurs or region B where no sheer stress occurs. The region A (where the shear stress is relatively higher) corresponds to the black mura region, and the region B (where the shear stress is relatively lower) corresponds to the normal region in which there is no black mura.

Each of the first and second insulation substrates 110 and 210 is an optically isotropic and homogeneous transparent body, and may be formed of glass or plastic. However, when an external force is applied such that the first and second insulation substrates 110 and 210 have curvatures, the first and second insulation substrates 110 and 210 have birefringence, thus losing their optically isotropic property. The degree of birefringence is proportional to the external force. The polarized light becomes elliptically polarized light when it is transmitted through the transparent body having birefringence. In the elliptically polarized light, an end of a vibration vector of a light wave moves with an elliptical motion. When viewed by a viewer in a direction in which the light wave travels, the elliptically polarized light may be either one of right elliptically polarized light rotating in a clockwise direction and left elliptically polarized light rotating in a counterclockwise direction. The elliptically polarized light may be a combination of two linearly polarized lights vibrating in directions perpendicular to each other.

Since the light emitted from the backlight is unpolarized, the light remains unpolarized even when it is transmitted through the region A (where the shear stress is relatively higher) and the region B (where the shear stress is relatively lower). Since polarized light vibrating in one direction along a first polarization axis P1 can be transmitted through the first polarizer POL1, the unpolarized light becomes linearly polarized light in the direction of the first polarization axis P1 when it is transmitted through the first polarizer POL1. Since the curved LCD displays the black image, the linearly polarized light in the direction of the first polarization axis P1 is transmitted through the liquid crystal layer 3 with its polarization unchanged. The second polarizer POL2 has a second polarization axis P2 that is perpendicular to the first polarization axis P1 of the first polarizer POL1. The linearly polarized light in the direction of the first polarization axis P1 is not transmitted through the second polarizer POL2. As a result, no light is transmitted through the second insulation substrate 210, and the black image may be displayed. As such, there is no black mura in both the region A (where the shear stress is relatively higher) and the region B (where the shear stress is relatively lower) of the liquid crystal panel assembly 1500. That is, no black mura occurs in both the black mura region and the normal region of the liquid crystal panel assembly 1500.

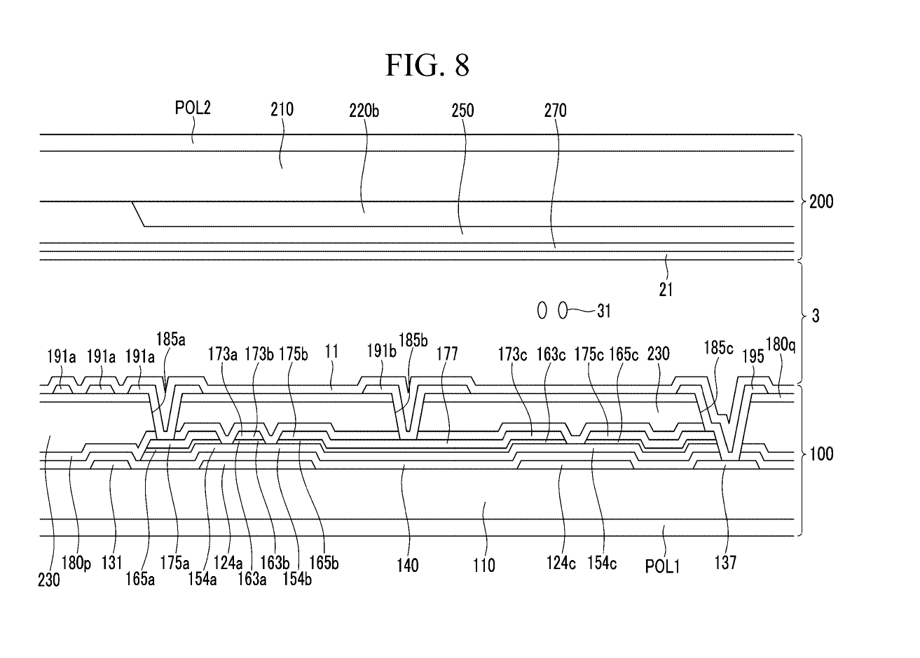

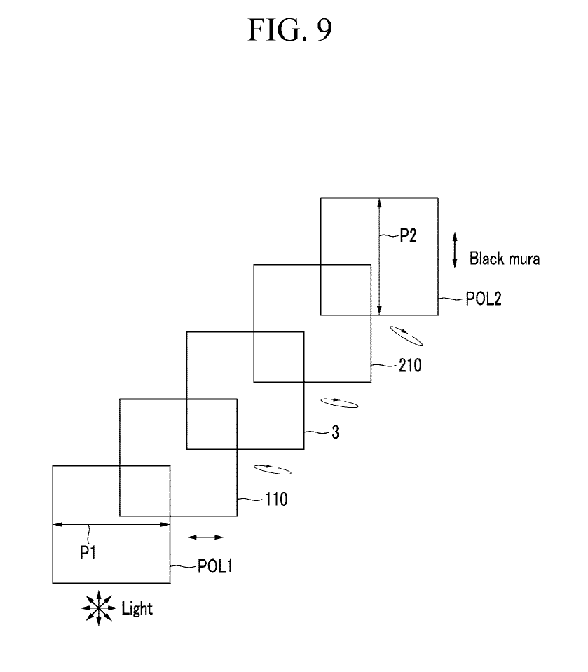

FIG. 8 is a cross-sectional view illustrating a curved LCD according to a comparative example. FIG. 9 is a top plan view illustrating polarization variations in a black mura region in the curved LCD of FIG. 8.

Unlike the embodiment in FIG. 4, the first and second polarizers POL1 and POL2 in the comparative example of FIG. 8 are disposed outside the pixel cells of the curved LCD. That is, the first and second polarizers POL1 and POL2 in the comparative example of FIG. 8 are disposed outside the first and second insulation substrates 110 and 210.

In the comparative example of FIG. 8, light emitted from the backlight becomes linearly polarized in a direction of the first polarization axis P1 after it is transmitted through the first polarizer POL1. Assuming that the linearly polarized light in the direction of the first polarization axis P1 is transmitted through the region A (where the shear stress is relatively higher, that is, in the black mura region), the linearly polarized light in the direction of the first polarization axis P1 becomes elliptically polarized light after it is transmitted through the first insulation substrate 110. The elliptically polarized light includes a linearly polarized light component in the direction of the first polarization axis P1 and a linearly polarized light component in a direction of the second polarization axis P2. Since the curved LCD displays the black image, no electric field is generated in the liquid crystal layer 3, and the elliptically polarized light is transmitted through the liquid crystal layer 3 with its polarization unchanged.

Since the second insulation substrate 210 also has birefringence, the elliptically polarized light may have its linearly polarized light component in the direction of the second polarization axis P2 after it is transmitted through the second insulation substrate 210. The linearly polarized light component in the direction of the second polarization axis P2 includes the elliptically polarized light that is transmitted through the second polarizer POL2. After the linearly polarized light is transmitted through the second polarizer POL2 in the direction of the second polarization axis P2, the image rendered by the linearly polarized light will be recognized by a viewer. Accordingly, black mura occurs on the black screen, whereby a specific area is displayed brighter than its surrounding areas.

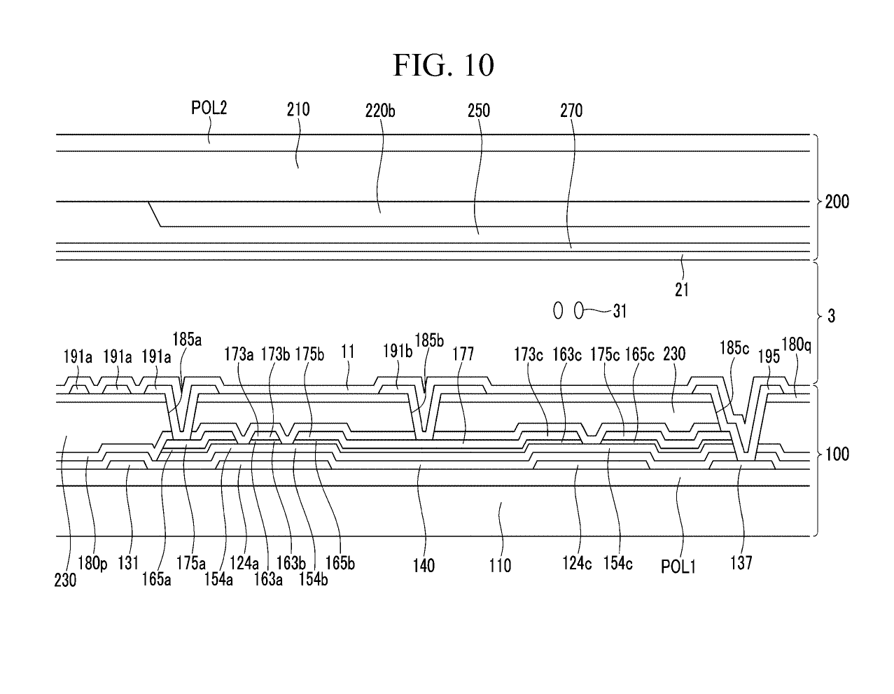

FIG. 10 is a cross-sectional view illustrating a curved LCD according to another exemplary embodiment.

In contrast to the embodiment in FIG. 4, a first polarizer POL1 is disposed inside the pixel cells of the curved LCD and a second polarizer POL2 is disposed outside the pixel cells of the curved LCD in the embodiment in FIG. 10. Specifically, a horizontal light blocking member 220b, an overcoat 250, a common electrode 270, and an alignment layer 21 are sequentially disposed on a second insulation substrate 210, with the second polarizer POL2 disposed opposite thereto. The second polarizer POL2 may be formed as a film that is attached to the second insulation substrate 210. It is noted that when the second polarizer POL2 is disposed inside the pixel cells, there may be difficulties in implementing a wide viewing angle in the curved LCD. However, the difficulties can be reduced by disposing the second polarizer POL2 outside the liquid crystal panel assembly 1500. In some instances, since the second polarizer POL2 is disposed outside the pixel cells of the curved LCD, the efficiency in removing the black mura may be reduced.

The accompanying drawings and the detailed description of the inventive concept are merely illustrative and are used to describe the inventive concept, and should not be construed as limiting the inventive concept. Instead, one of ordinary skill in the art will understand that various modifications may be made to the embodiments without departing from the scope of the inventive concept.

What is claimed is:

1. A curved liquid crystal display (LCD) comprising:
a curved liquid crystal panel assembly including a first insulation substrate and a second insulation substrate facing each other and a liquid crystal layer interposed therebetween;
a first polarizer disposed on the first insulation substrate; and
a second polarizer disposed on the second insulation substrate, wherein
the first polarizer is disposed inside the curved liquid crystal panel assembly.

2. The curved LCD of claim 1, wherein the first polarizer is disposed in a first region corresponding to a black mura region in which black mura generated in the curved liquid crystal panel assembly appears.

3. The curved LCD of claim 2, wherein the first polarizer is disposed in a second region corresponding to a normal region excluding the black mura region.

4. The curved LCD of claim 3, wherein the second polarizer is disposed in the first region corresponding to the black mura region.

5. The curved LCD of claim 4, wherein the second polarizer is disposed in the second region corresponding to the normal region.

6. The curved LCD of claim 3, wherein a shear stress of the liquid crystal panel assembly is higher in the black mura region than in the normal region.

7. The curved LCD of claim 1, wherein the second polarizer is disposed inside the curved liquid crystal panel assembly.

8. The curved LCD of claim 1, wherein the second polarizer is disposed outside the curved liquid crystal panel assembly.

9. The curved LCD of claim 1, wherein a first polarization axis of the first polarizer and a second polarization axis of the second polarizer are perpendicular to each other.

10. The curved LCD of claim 1, wherein the curved liquid crystal panel assembly is formed having a predetermined constant curvature.

11. The curved LCD of claim 1, wherein the curved liquid crystal panel assembly is formed having multiple curvatures such that its center portion has a different curvature from the lateral edge portions.

12. The curved LCD of claim 1, wherein the liquid crystal layer includes a plurality of liquid crystal molecules, and the plurality of liquid crystal molecules are aligned such that they are perpendicular to surfaces of the first and second insulation substrates when no electric field is being generated in the liquid crystal panel assembly.

13. A curved liquid crystal display (LCD) comprising a curved liquid crystal panel assembly including a first polarizer and a second polarizer facing each other, wherein the first polarizer is positioned inside the curved liquid crystal panel assembly and disposed in a first region corresponding to a black mura region in which black mura generated in the curved liquid crystal panel assembly appears.

14. The curved LCD of claim 13, wherein the second polarizer is disposed inside the curved liquid crystal panel assembly and disposed in the first region corresponding to the black mura region.

15. The curved LCD of claim 14, wherein the first polarizer is disposed in a second region corresponding to a normal region excluding the black mura region.

16. The curved LCD of claim 15, wherein the second polarizer is disposed in the second region corresponding to the normal region.

17. The curved LCD of claim 15, wherein a shear stress of the liquid crystal panel assembly is higher in the black mura region than in the normal region.

18. The curved LCD of claim 13, wherein the second polarizer is disposed inside the curved liquid crystal panel assembly.

19. The curved LCD of claim 13, wherein the second polarizer is disposed outside the curved liquid crystal panel assembly.
